(19) United States
(12) Patent Application Publication
(10) Pub. No.: US 2012/0299925 A1
(43) Pub. Date: Nov. 29, 2012

(54) DETERMINING AFFINITY IN SOCIAL NETWORKS

(75) Inventors: Marc A. Najork, Palo Alto, CA (US); Rina Panigrahy, San Ramon, CA (US)

(73) Assignee: Microsoft Corporation, Redmond, WA (US)

(21) Appl. No.: 13/113,103

(22) Filed: May 23, 2011

(51) Int. Cl. G06T 11/20; G06F 15/16

(52) U.S. Cl. 345/440

(57) ABSTRACT

A graph is generated based on a social networking application with a node for each user account, and one or more edges representing the social networking relationships between the user accounts (e.g., friends). A sketch is generated for each node in iterations where edges are removed from the graph and a set of reachable nodes is determined for the node. A representative node is then selected from the set of reachable nodes and added to the sketch as a dimension. The generated sketches for two nodes are used to calculate an affinity score between the accounts associated with each of the two nodes.

### BACKGROUND

Social networks can be modeled using a graph. For example, each user account may be represented as a node in the graph with an edge between nodes that represent social networking relationships between the user accounts. The social networking relationships may include “friend” or “follower” relationships, for example.

The “social distance” between two user accounts in a social network is one measure of the affinity between two user accounts in the social network. There are many ways to determine the social distance between two users. For example, one method for measuring the social distance between two user accounts is determining the minimum distance between the nodes associated with the user accounts. In a graph, the minimum distance is the minimum number of edges that are traversed on a path between the nodes associated with the user accounts in the social network. While such a measure of social distance is useful, it may not accurately reflect the true social distance between users associated with user accounts. Another measure of affinity is how “robustly” connected two users are, that is, how many independent paths connect the users in the social network.

### SUMMARY

The present disclosure introduces an affinity measure that is influenced both by the distance between two users in the social network and the robustness of their connection. Given two users, their affinity is computed in a highly efficient manner. A graph is generated based on a social networking application and includes a node for each user account and one or more edges representing the social networking relationships between the user accounts (e.g., friend relationships). A sketch is generated for each node in iterations where edges are removed from the graph at each iteration and a set of reachable nodes is determined for the node. A representative node is then selected from the set of reachable nodes and added to the sketch as a dimension. The generated sketches for two nodes are used to calculate an affinity score between the accounts associated with each of the two nodes. A high affinity score between two users may indicate similar tastes and interests for the users.

In an implementation, a graph is received by a computing device. The graph includes nodes and edges connecting the nodes. A sketch is generated for each node in the graph by the computing device. Each sketch comprises dimensions, and each dimension identifies a subset of the nodes and each dimension corresponds to a subset of the edges. An identifier of a first node and an identifier of a second node from the nodes are received by the computing device. A first sketch corresponding to the first node and a second sketch corresponding to the second node are retrieved by the computing device. A count of the number of dimensions from the first sketch and the number of dimensions from the second sketch that identify the same subset of the nodes for a corresponding subset of the edges is determined by the computing device. The determined count is provided as an affinity score for the first and the second nodes by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

To facilitate an understanding of and for the purpose of illustrating the present disclosure and various implementations, exemplary features and implementations are disclosed in, and are better understood when read in conjunction with, the accompanying drawings—it being understood, however, that the present disclosure is not limited to the specific methods, precise arrangements, and instrumentalities disclosed. Similar reference characters denote similar elements throughout the several views. In the drawings:

FIG. 1 is an illustration of an example environment using an affinity server;

FIG. 2 is an illustration of an example affinity server;

FIG. 3 is an illustration of sample sketches;

FIG. 4 is an operational flow of an implementation of a method for determining an affinity score for two user accounts of a social networking application;

FIG. 5 is an operational flow of an implementation of a method for determining a sketch for a node in a graph; and

FIG. 6 shows an exemplary computing environment.

### DETAILED DESCRIPTION

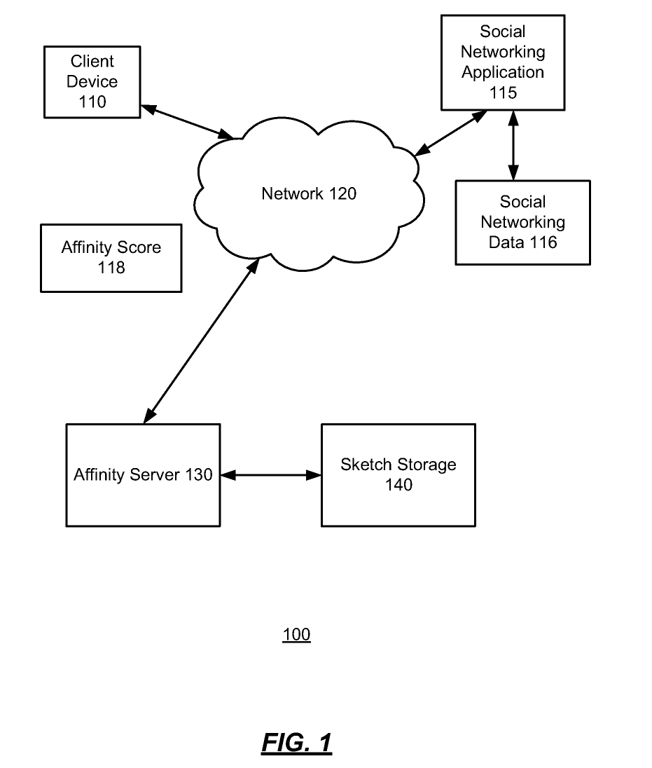

FIG. 1 is an illustration of an example environment 100 using a affinity server 130. The environment 100 may include a client device 110, a social networking application 115, and the affinity server 130 in communication with one another through a network 120. The network 120 may be a variety of network types including the public switched telephone network (PSTN), a cellular telephone network, and a packet switched network (e.g., the Internet). Although shown as comprised within separate devices over the network 120, depending on the implementation, the client device 110, the affinity server 130, and the social networking application 115 may be comprised within a single computing device, or one or more devices that do not communicate over the network 120.

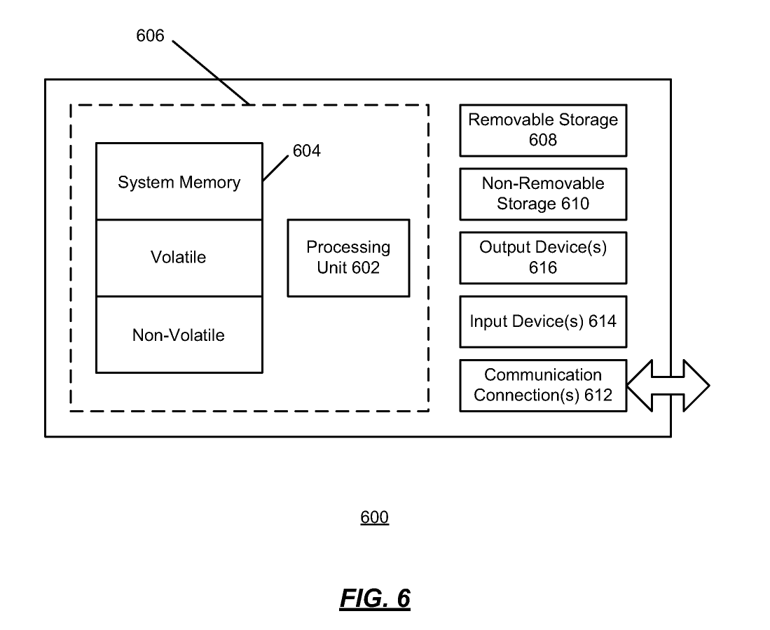

In some implementations, the client device 110 may include a desktop personal computer, workstation, laptop, PDA (personal digital assistant), smart phone, cell phone, or any WAP (wireless application protocol) enabled device or any other computing device capable of interfacing directly or indirectly with the network 120. A client device 110 may be implemented using a general purpose computing device such as the computing device 600 described with respect to FIG. 6, for example. While only one client device 110 is shown, it is for illustrative purposes only; multiple client devices may be supported.

The social networking application 115 may provide social networking functionality to users of client devices. In some implementations, each user may have a user account associated with the social networking application 115. The user may establish social networking relationships with one or more users of the social networking application 115. The social networking relationships may include a friend based relationship where the user and one or more other users are able to share messages, view profile information associated with one another, post public messages on walls associated with each other, and recommend content items and/or other users to each other, for example. Other well known social networking relationships may also be supported. The social networking application 115 may include a variety of well known social networking applications.

The social networking application 115 may store and/or access social networking data 116. In some implementations, the social networking data 116 may include an identifier of each user account, and identifiers of the various social networking relationships between the user accounts, as well as any messages and/or content items shared between the user accounts. For example, where the social networking relationship is a friend relationship, the social networking data 116 may include a data tuple for each user account with a pointer to each user account that the user account has a friend relationship with. Any one of a variety of data structures may be used to store the social networking data 116.

The social networking application 115 may provide the social networking data 116 to the affinity server 130, and the affinity server 130 may use some or all of the social networking data 116 to generate an affinity score 118 between user accounts of the social networking application 115. In some implementations, the affinity score 118 may be a measure of the affinity of a pair of user accounts in the social networking application 115. A high affinity score 118 for a pair of user accounts may indicate that the user accounts have a high affinity and a low affinity score 118 may indicate that the user accounts have a low affinity. In some implementations, the affinity score 118 may be a mix of the distance between two user accounts (the closer two nodes, the higher their affinity) and the number of paths between two user accounts (the higher the number of disjoint paths, the higher the affinity).

The affinity server 130 may provide the affinity scores 118 to the social networking application 115. The social networking application 115 may display the affinity scores 118 to one or more users. For example, the social networking application 115 may display the affinity score 118 between a user account and one or more selected user accounts.

In addition, in some implementations, the determined affinity scores may be used by the social networking application 115 to recommend one or more content items to a user. The content items may include documents, advertisements, audio and video files, search results, etc. For example, the social networking application 115 may rank search results for a user account based on the searches performed by other users associated with user accounts having high affinity scores with respect to the user account. In another example, the social networking application 115 may recommend articles, videos, or music based on the tastes of other users associated with user accounts having high affinity scores with respect to the user account of the user.

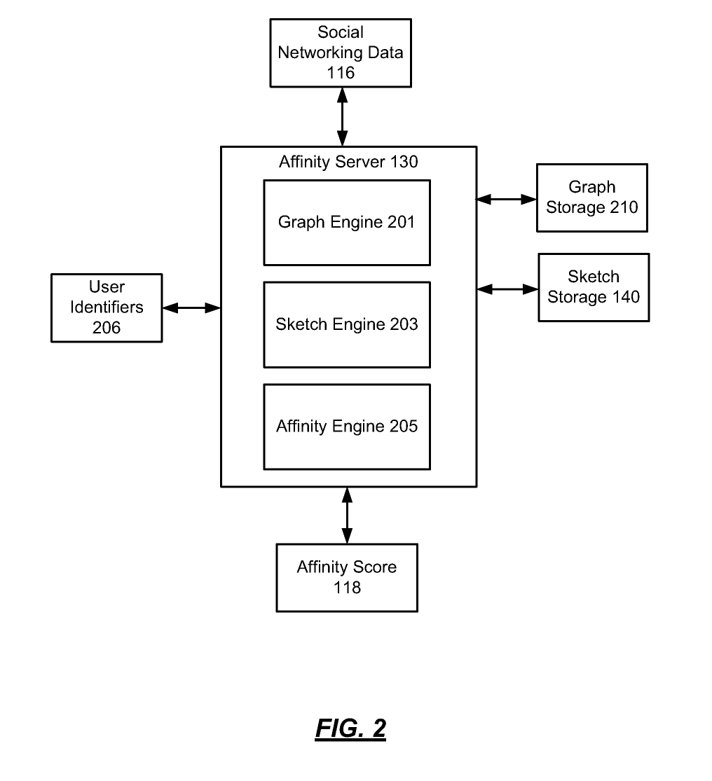

As described further with respect to FIG. 2, the affinity server 130 may generate the affinity scores by generating a graph based on the social networking data 116. In some implementations, the graph may include a node for each user account and an edge connecting each node representing one or more social networking relationships between the user accounts. The affinity server 130 may generate a sketch for each node in the graph. The sketches associated with the nodes may be used to generate the affinity scores.

FIG. 2 is an illustration of an example affinity server 130. As illustrated, the affinity server 130 includes a graph engine 201, a sketch engine 203, and an affinity engine 205. More or fewer components may be supported by the affinity server 130. The affinity server 130 may be implemented using a general purpose computing device such as the computing device 600 described with respect to FIG. 6, for example.

The graph engine 201 may generate a graph based on social networking data 116. In some implementations, the graph may include a node for each user account associated with the social networking application 115 and an edge between nodes that represent the social networking relationships between each user account associated with the nodes. For example, an edge may be generated between two nodes representing user accounts that are friends in the social networking application 115. The generated graph may be stored by the graph engine 201 in a graph storage 210.

In some implementations, the graph engine 201 may weight edges based on the strength of the social networking relationships. For example, an edge between nodes associated with user accounts that exchange messages may be weighted higher than an edge between nodes associated with user accounts who are merely friends but do not otherwise exchange communications through the social networking application 115.

In some implementations, the graph may be an undirected graph. In an undirected graph, edges between nodes may be traversed in either direction. Thus, if a first node is reachable on a path from a second node, then the second node is also reachable on the path from the first node. An example of an undirected social networking relationship is the friend relationship because if a first user is friends with a second user, the second user is also friends with the first user.

In other implementations, the graph may be a directed graph. In a directed graph, edges between nodes may be traversed in only one direction. Thus, if a first node is reachable on a path from a second node, then the second node is not reachable on the same path from the first node. An example of a directed social networking relationship is the follower relationship because if a first user follows a second user, the second user is not necessarily a follower of the first user.

The sketch engine 203 may generate a sketch for each node in the graph representing the social networking data 116. The generated sketches may be stored by the sketch engine 203 in a sketch storage 140.

In some implementations, a generated sketch for a node may include a plurality of dimensions, and each dimension may be associated with a different subset of the edges of the generated graph. Each subset associated with a dimension may be itself a subset of the subset associated with a previous dimension of the sketch. Thus, each dimension in a sketch is associated with a smaller subset of edges from the generated graph than a previous dimension of the sketch.

Each dimension in the sketch may identify a subset of nodes. In some implementations, the identified subset of nodes may be a subset of nodes that are reachable from the node associated with the sketch using the subset of edges corresponding to the dimension. A node is reachable from another node if there is path between the nodes formed by following one or more edges between the nodes. Any of a variety of methods for determining reachable nodes may be used by the sketch engine 203.

Alternatively, in some implementations, each dimension in the sketch may identify a representative node. The sketch engine 203 may select a node from the set of reachable nodes as the identified representative node. The sketch engine 203 may select the representative node in such a way that, for each sketch generated, the same representative node may be selected for identical sets of reachable nodes. In some implementations, each node in the graph may have an associated identifier such as a unique number. The sketch engine 203 may then select the node from the set of reachable nodes having the maximum number as the representative node, or the minimum number as the representative node, depending on the implementation.

The sketch engine 203 may generate the sketches for each node of the graph in iterations. At a first iteration, the sketch engine 203 may determine, for each node, a set of nodes that are reachable from the node and may determine a representative node for the set of reachable nodes. The sketch engine 203 may then, for each node, associate the determined representative node with the first dimension of the sketch generated for the node. Alternatively, the sketch engine 203 may, for each node, associate the set of reachable nodes with the first dimension of the sketch generated for the node.

At a second iteration, the sketch engine 203 may generate a subset of the edges in the graph by removing one or more edges from the graph. For example, the sketch engine 203 may remove ten percent of the edges from the graph, and the remaining edges may be part of the subset of edges. Other percentages of edges may be removed, such as five percent, twenty percent, etc.

The sketch engine 203 may then determine, for each node, a set of nodes that are reachable from the node using the edges from the subset of edges and may determine a representative node for the set of reachable nodes. The sketch engine 203 may, for each node, associate the determined representative node with the second dimension of the sketch generated for the node. Alternatively, the sketch engine 203 may, for each node, associate the set of reachable nodes with the second dimension of the sketch generated for the node.

The sketch engine 203 may continue to generate dimensions for each sketch as described above. The number of dimensions generated for each sketch by the sketch engine 203 may be selected by a user or administrator. There is no minimum or maximum numbers of dimensions that may be supported by each sketch.

In some implementations, the number of edges removed from the graph between iterations may be fixed. For example, the sketch engine 203 may remove ten percent of the edges at each iteration. Alternatively, the sketch engine 203 may remove a variable amount of edges at each iteration. For example, the sketch engine 203 may remove ten percent of the edges at the first iteration, fifteen percent of the edges at the second iteration, and twenty percent of the edges at the third iteration. In some implementations, the number of edges removed at each iteration may be based on the connectivity of the original graph, or the graph formed by the edges remaining at the iteration.

In some implementations, the edges removed from the graph by the sketch engine 203 may be uniformly selected at random by the sketch engine 203. Alternatively, the sketch engine 203 may remove edges from the graph inversely biased by the relative strength or importance of the social networking relationship associated with each edge. For example, edges in the graph that represent friend relationships may be removed from the graph before edges that represent wall postings or messages sent between user accounts of the social networking application 115.

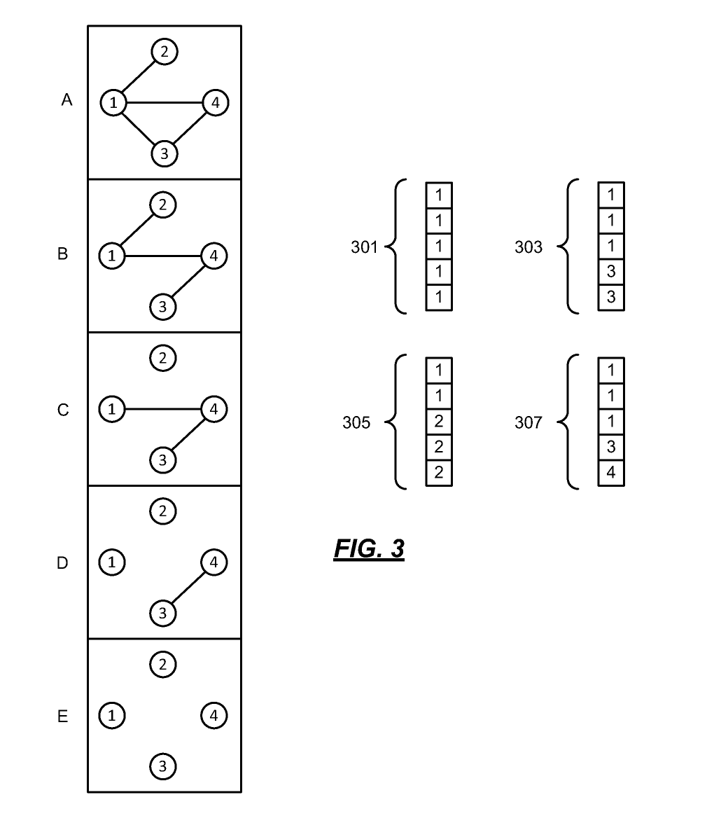

As an example, FIG. 3 is an illustration of sample sketches 301, 303, 305, and 307 generated by the sketch engine 203 for four nodes 1, 2, 3, and 4 of a graph. Each sketch comprises five dimensions as shown by the five boxes corresponding to each of the sketches 301, 303,305, and 307. Each dimension corresponds to an iteration of the graph labeled A, B, C, D, and E. The dimensions of each sketch are ordered from top to bottom with the dimension A in each sketch represented by the top-most box, and the dimension E in each sketch represented by the bottom-most box.

As illustrated, the dimension A corresponds to a subset of the graph formed by removing an edge between the nodes 2 and 4. The dimension B corresponds to a subset of the graph corresponding to the dimension A formed by removing an edge between the nodes 1 and 3. The dimension C corresponds to a subset of the graph corresponding to the dimension B formed by removing an edge between the nodes 1 and 2. The dimension D corresponds to a subset of the graph corresponding to the dimension C formed by removing an edge between the nodes 1 and 4. The dimension E corresponds to a subset of the graph corresponding to the dimension D formed by removing an edge between the nodes 4 and 3.

Each of the boxes representing the dimensions of the sketches 301, 303, 305, and 307 has a number that identifies the associated representative node for the dimension. In the examples shown, the number identifies the node that is reachable from the node associated with the sketch with the minimum identifier. As illustrated, the dimension A, the dimension B, the dimension C, the dimension D, and the dimension E of the sketch 301 each identify node 1; the dimension A, the dimension B, the dimension C, the dimension D, and the dimension E of the sketch 303 each identify nodes 1, 1, 1, 3, and 3, respectively; the dimension A, the dimension B, the dimension C, the dimension D, and the dimension E of the sketch 305 each identify nodes 1, 1, 2, 2, and 2, respectively; and the dimension A, the dimension B, the dimension C, the dimension D, and the dimension E of the sketch 307 each identify nodes 1, 1, 1, 3, and 4, respectively.

The affinity engine 205 may generate an affinity score 118 between two user accounts in the social networking application 115 based on the sketches associated with the nodes corresponding to each user account. In some implementations, the affinity score 118 may be based on the first dimension where two sketches do not identify the same representative node. In other implementations, the affinity score 118 may be based on a count of the number of dimensions from each sketch that identify or are associated with the same representative node for the same dimension.

Continuing the example shown in FIG. 3, the affinity engine 205 may determine an affinity score 118 between a user account associated with the node 1 corresponding to the sketch 301 and the user accounts associated with the nodes 2, 3, and 4 corresponding to the sketches 303, 305, and 307, respectively. With respect to the sketches 301 and 303, both sketches identify the same representative node (i.e., 1) for dimensions A, B, and C, but identify different representative nodes starting with dimension D. Thus, the affinity score 118 between the user account associated with node corresponding to the sketch 301 and the user account associated with node corresponding to the sketch 303 is three.

With respect to the sketches 301 and 305, both sketches identify the same representative node (i.e., 1) for dimensions A and B, but identify different representative nodes starting with dimension C. Thus, the affinity score 118 between the user account associated with node corresponding to the sketch 301 and the user account associated with node corresponding to the sketch 305 is two.

With respect to the sketches 301 and 307, both sketches identify the same representative node (i.e., 1) for dimensions A, B, and C but identify different representative nodes starting with dimension D. Thus, the affinity score 118 between the user account associated with node corresponding to the sketch 301 and the user account associated with node corresponding to the sketch 307 is three.

As can be appreciated, the edges removed from the graph for each iteration may affect the representative node selected for the dimension of the sketches, and as a result the affinity scores that are generated using the sketches. Accordingly, to balance out the effects of removing certain edges, the sketch engine 203 may generate a plurality of sketches for each node, rather than a single sketch as described above. Each sketch generated for a node may have a different sequence of subsets of edges corresponding to each dimension. The affinity engine 205 may then determine an affinity score 118 for two nodes based on all of the sketches associated with the nodes rather than just two. In some implementations, each subset of edges in a sequence of subsets of edges may be a subset of a previous subset of edges in the sequence.

In some implementations, the affinity engine 205 may generate an affinity score 118 for a node pair using the sketch associated with each node for each different sequence of subsets of edges, and may take the average affinity score as the affinity score 118 for the node pair. In other implementations, the affinity engine 205 may generate an affinity score 118 for a pair of nodes using the plurality of sketches associated with each node by comparing pairs of sketches that were generated using the same sequences of subsets of edges. The affinity engine 205 may then determine the affinity score 118 based on the first dimension where the number of pairs of sketches that disagree for that dimension exceeds a threshold percentage. The threshold percentage may be 50 percent. Other threshold percentages may be used.

For example, 100 sketches may be generated for each node. Each sketch may be generated by removing different edges for each sketch dimension. The same number of edges may be removed for each dimension. The edges removed for each sketch dimension may be selected randomly. Thus, for a node A and a node B, there may be 100 pairs of sketches between the nodes. The affinity engine 205 may then determine the percentage or fraction of these 100 pairs that identify the same representative node starting at the first dimension. The affinity engine 205 may continue determining the percentage for each dimension until a dimension is reached where the percentage falls below the threshold percentage. The number of the last dimension reached may then be provided as the affinity score 118.

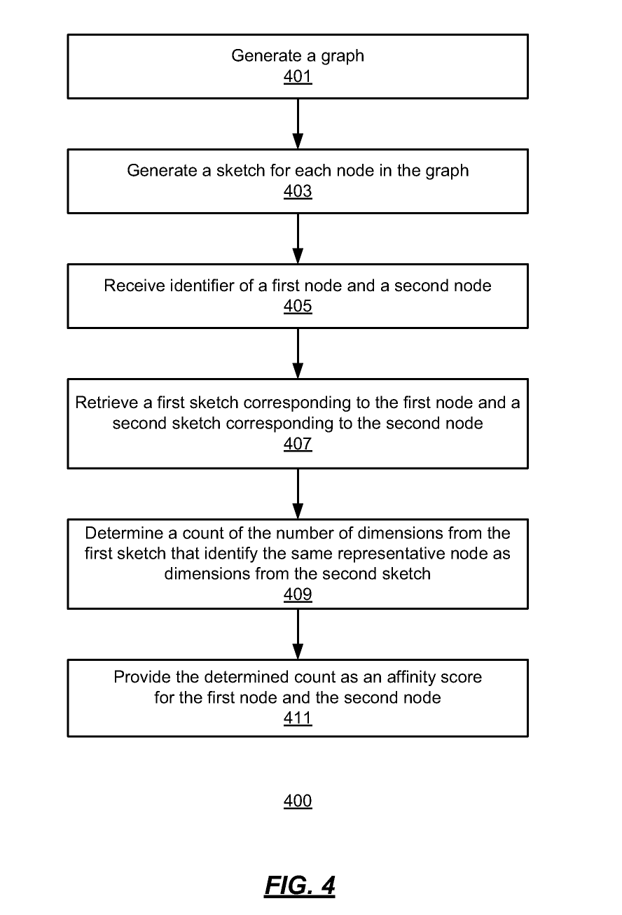

FIG. 4 is an operational flow of an implementation of a method 400 for determining an affinity score for two user accounts of a social networking application. The method 400 may be implemented by the affinity server 130 and/or a social networking application 115, for example.

A graph is generated at 401. The graph may be generated by the graph engine 201 of the affinity server 130. The graph may be generated from social networking data 116 and may include a node associated with each user account from the social networking data 116 and an edge corresponding to each social networking relationship between the user accounts. Alternatively, the graph may be generated by the social networking application 115 and received by the affinity server 130.

A sketch is generated for each node in the graph at 403. The sketches may be generated by the sketch engine 203 of the affinity server 130 and stored in the sketch storage 140. Each sketch may include a plurality of dimensions, and each dimension may indicate a representative node from the nodes of the graph. Each dimension may correspond to a subset of edges from the graph, and the identified representative node for a dimension may be a node that is reachable from the node associated with the sketch using the subset of edges. Alternatively, each dimension may identify the nodes that are reachable, rather than a representative node of the reachable nodes.

An identifier of a first node and an identifier of a second node are received at 405. The identifiers may be received by the affinity server 130 from the social networking application 115. The identifiers may be associated with a request for an affinity score 118 between a user account associated with the first node and a user account associated with the second node.

A first sketch corresponding to the first node and a second sketch corresponding to the second node are retrieved at 407. The first sketch and second sketch may be retrieved from the sketch storage 140 by the affinity engine 205 of the affinity server 130.

A count of the number of dimensions from the first sketch and the second sketch that identify the same representative node is determined at 409. The count may be determined by the affinity engine 205 by comparing the identified representative node of a dimension from the first sketch with the identified representative node of the same dimension from the second sketch and determining if they are the same node. If so, the count may be incremented. Alternatively, a count of the number of dimensions from the first sketch and the second sketch that identify the same reachable nodes may be determined.

In some implementations, the count may identify the highest dimension before the remaining nodes identified by the first and second sketch start to disagree. Thus, if the first and the second sketches identify the same nodes for a first and a second dimension of the first sketch and the second sketch, but identify different nodes for a third dimension, then the count may be two.

The determined count is provided as an affinity score between the first node and the second node at 411. The determined count may be provided by the affinity engine 205 to the social networking application 115. The social networking application 115 may display the affinity score 118 to a user associated with the first node, or may use the affinity score 118 to recommend one or more content items to the users associated with the first or second nodes. For example, if the first and second nodes have high affinity score 118, the social networking application 115 may recommend movies, music, products, or rank search results provided to the user associated with the first node based on the movies, music, products, or search habits of the user associated with the second node.

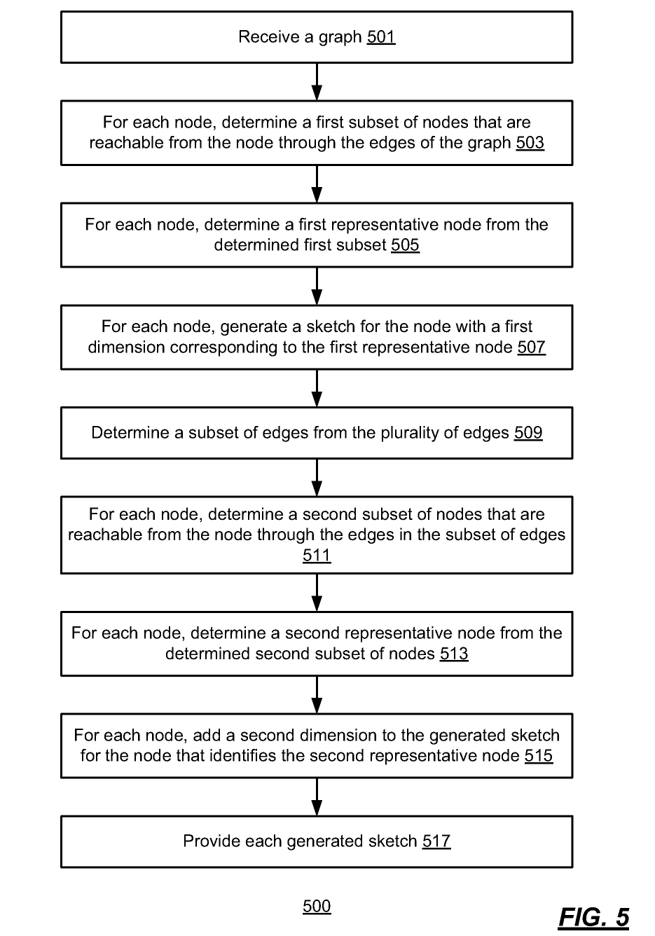

FIG. 5 is an operational flow of an implementation of a method 500 for determining a sketch for a node in a graph. The method 500 may be implemented by the affinity server 130, for example.

A graph is received at 501. The graph may be received by the sketch engine 203 of the affinity server 130 from the graph engine 201. Alternatively or additionally, the graph may be received from the social networking application 115. The graph may include a plurality of nodes and a plurality of edges connecting one or more nodes together. The graph may represent user accounts in the social networking application and may include a node for each user account, and an edge between node pairs representing a social networking relationship between the user accounts associated with each node in the pair.

For each node, a first subset of nodes that are reachable from the node through the edges of the graph is determined at 503. The first subset of nodes may be determined by the sketch engine 203 of the affinity server 130. Any method for determining reachable nodes in a graph may be used.

For each node, a first representative node from the first subset of nodes is determined at 505. The first representative node may be determined by the sketch engine 203 of the affinity server 130. Where the nodes have node identifiers, the first representative node may be determined by determining the node with the minimum, or alternatively the maximum (depending on the implementation), node identifier from the nodes of the first subset of nodes.

For each node, a sketch is generated for the node with a first dimension identifying the first representative node at 507. The sketch may be generated by the sketch engine 203 of the affinity server 130. Alternatively, the sketch may be generated for a node with a first dimension identifying the first subset of nodes. The generated sketches may be stored by the sketch engine 203 in the sketch storage 140.

A subset of edges from the plurality of edges is determined at 509. The subset of edges may be determined by the sketch engine 203 of the affinity server 130. In some implementations, the subset of edges may be determined by removing one or more edges from the received graph, and the remaining edges of the graph may be the determined subset. In some implementations, ten percent of the edges may be removed from the graph; however, more or fewer edges may be removed.

For each node, a second subset of nodes that are reachable from the node through the subset of edges of the graph is determined at 511. The second subset of nodes may be determined by the sketch engine 203 of the affinity server 130.

For each node, a second representative node from the second subset of nodes is determined at 513. The second representative node may be determined by the sketch engine 203 of the affinity server 130.

For each node, a second dimension is added to the sketch associated with the node that identifies the second representative node at 515. The second dimension may be added by the sketch engine 203 of the affinity server 130. Alternatively, the sketch may be generated for a node with a second dimension identifying the second subset of nodes. In some implementations, the sketch engine 203 may continue to generate each sketch by adding dimensions for decreasing sized subsets of edges.

The generated sketches are provided at 517. The generated sketches may be provided by the sketch engine 203 to the affinity engine 205 of the affinity server 130. The affinity engine 205 may use the generated sketches to determine affinity scores between the pairs of user accounts in the social networking application 115.

FIG. 6 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by device 600 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a graph by a computing device, wherein the graph comprises a plurality of nodes and a plurality of edges connecting the plurality of nodes;
generating a sketch for each node in the graph by the computing device, wherein the sketch comprises a plurality of dimensions and each dimension identifies a subset of the plurality of nodes and each dimension corresponds to a subset of the plurality of edges;
receiving an identifier of a first node from the plurality of nodes and an identifier of a second node from the plurality of nodes by the computing device;
retrieving a first sketch corresponding to the first node and a second sketch corresponding to the second node by the computing device;
determining a highest dimension from the first sketch and the second sketch that identifies the same subset of the plurality of nodes for a corresponding subset of the plurality of edges by the computing device; and
providing an indicator of the highest dimension as an affinity score for the first node and the second node by the computing device.

2. The method of claim 1, wherein the graph corresponds to a social network and each node corresponds to a user account of the social network and each edge corresponds to a social networking relationship between the user accounts associated with the nodes that the edge connects.

3. The method of claim 1, wherein generating a sketch for a node in the graph comprises, for each dimension of the sketch:
generating the subset of the plurality of edges corresponding to the dimension by removing one or more edges from the plurality of edges from the graph; and
determining a subset of the plurality of nodes that the node is connected to through the plurality of edges corresponding to the dimension.

4. The method of claim 1, wherein each dimension identifies a representative node from a subset of the plurality of nodes.

5. The method of claim 1, wherein the subset of the plurality of edges corresponding to each dimension of a sketch is smaller than a subset of the plurality of edges corresponding to a previous dimension of a sketch.

6. The method of claim 1, wherein the edges in the graph are weighted based on a strength of a social networking relationship associated with each edge.

7. The method of claim 1, further comprising recommending one or more content items using the affinity score.

8. The method of claim 7, wherein the content items comprise one or more of search results, advertisements, and documents.

9. A method comprising:
receiving a graph by a computing device, wherein the graph comprises a plurality of nodes and a plurality of edges connecting the plurality of nodes;
for each node in the plurality of nodes:
determining a first subset of nodes from the plurality of nodes that the node is connected to through the plurality of edges by the computing device; and
generating a sketch for the node having a first dimension identifying the first subset of nodes by the computing device; and
providing the generated sketches by the computing device.

10. The method of claim 9, further comprising:
determining a first subset of edges from the plurality of edges; and
for each node in the plurality of nodes:
determining a second subset of nodes from the plurality of nodes that the node is connected to through the first subset of edges; and
adding a second dimension identifying the second subset of nodes to the generated sketch for the node.

11. The method of claim 10, further comprising:
determining a second subset of edges from the first subset of edges; and
for each node in the plurality of nodes:
determining a third subset of nodes from the plurality of nodes that the node is connected to through the second subset of edges; and
adding a third dimension identifying the third subset of nodes to the generated sketch for the node.

12. The method of claim 11, wherein the second subset of edges is determined by removing one or more edges from the first subset of edges.

13. The method of claim 12, wherein the number of edges removed from the first subset of edges is based on the connectivity of the graph.

14. The method of claim 9, wherein the first dimension identifies a representative node from the first subset of nodes.

15. The method of claim 9, wherein a plurality of sketches are generated for each node, and further comprising:
selecting a first node and a second node from the plurality of nodes;
determining a dimension of the plurality of sketches generated for the first node and the second node where a percentage of pairs of sketches from the plurality of sketches that disagree for the dimension exceeds a threshold percentage; and
providing the determined dimension as an affinity score for the first node and the second node.

16. The method of claim 9, further comprising:
selecting a first node and a second node from the plurality of nodes;
determining a count of the number of dimensions from a sketch associated with the first node and the number of dimensions from a sketch associated with the second node that identify the same determined subset of nodes; and
providing the determined count as an affinity score for the first node and the second node.

17. The method of claim 9, wherein a plurality of sketches are generated for each node, and further comprising:
selecting a first node and a second node from the plurality of nodes;
for each sketch from the plurality of sketches associated with first node and a corresponding sketch from the plurality of sketches associated with the second node, determining a count of the number of dimensions from the sketch associated with the first node and the number of dimensions from the sketch associated with the second node that identify the same determined subset of nodes;
averaging the determined counts to generate an average count; and
providing the average count as an affinity score for the first node and the second node.

18. A system comprising:
at least one computing device;
a graph engine adapted to generate a graph based on a social network, wherein the graph comprises a plurality of nodes with each node corresponding to each user account of a plurality of user accounts of the social network, and a plurality of edges connecting the plurality of nodes with each edge connecting a node pair representing one or more social networking relationships between the user accounts associated with the nodes of the node pair;
a sketch engine adapted to generate a sketch for each node in the graph, wherein a sketch comprises a plurality of dimensions and each dimension identifies a subset of nodes from the plurality of nodes and each dimension corresponds to a subset of the plurality of edges; and
an affinity engine adapted to:
receive an identifier of a first user account associated with a first node from the plurality of nodes and an identifier of a second user account associated with a second node from the plurality of nodes;
retrieve a first sketch corresponding to the first node and a second sketch corresponding to the second node;
determine a count of a number of dimensions from the first sketch and a number of dimensions from the second sketch that identify the same determined subset of nodes for a corresponding subset of the plurality of edges; and
provide the determined count as an affinity score for the first user account and the second user account.

19. The system of claim 18, wherein the one or more social networking relationships include a friend relationship.

20. The system of claim 18, wherein the affinity engine is further adapted to recommend one or more content items to a user associated with the first user account using the affinity score.
